(19) United States
(12) Patent Application Publication
(10) Pub. No.: US 2010/0264568 A1
(43) Pub. Date: Oct. 21, 2010

(54) SYSTEM AND METHOD FOR FORMING CERAMIC PRECURSOR MATERIAL FOR THIN-WALLED CERAMIC HONEYCOMB STRUCTURES

(75) Inventors: Rodney Gene Dunn, Radford, VA (US); Paul Michael Eicher, Dublin, VA (US); Susan Clair Lauderdale, Corning, NY (US); Christopher John Malarkey, Painted Post, NY (US)

Correspondence Address: CORNING INCORPORATED, SP-TI-3-1, CORNING, NY, 14831, US

(73) Assignee: Corning Incorporated, Corning, NY (US)

(21) Appl. No.: 12/743,438

(22) PCT Filed: Nov. 19, 2008
(86) PCT No.: PCT/US08/12924

§ 371 Date: May 18, 2010

Related U.S. Application Data
(60) Provisional application No. 61/004,678, filed on Nov. 29, 2007.

(51) Int. Cl. B29B 13/02; B29B 9/12

(52) U.S. Cl. 264/630; 264/118

(57) ABSTRACT

A method for forming a ceramic precursor material for use in extruding ceramic honeycomb green bodies is provided. First, a plurality of dry particulate ceramic precursor ingredients are mixed to achieve an initial particulate precursor mixture. This mixture includes a percentage of particles and agglomerates with the agglomerates exhibiting a size greater than the threshold size. Following mixing, the agglomerates in the initial particulate mixture are pulverized to reduce a maximum size of at least some of the agglomerates below the threshold size to form pulverized agglomerates. Finally, a portion of the ceramic precursor ingredients are separated from the initial mixture with that portion comprising at least some of the pulverized agglomerates and at least some of the particles. The method is particularly adapted for use in the fabrication of ceramic honeycomb green bodies having thin webs between 2 and 5 mils in thickness.

### CROSS-REFERENCE TO RELATED APPLICATIONS

This application claims the benefit of priority under 35 U.S.C. §119(e) of U.S. Provisional Application Ser. No. 61/004,678 filed on Nov. 29, 2007.

### TECHNICAL FIELD

This invention generally relates to techniques for producing a ceramic precursor material for use in extruding ceramic honeycomb green bodies, and is specifically concerned with a system and method for producing a particulate ceramic precursor mix capable of being extruded into thin-walled ceramic honeycomb structures

### BACKGROUND

Ceramic honeycomb structures are widely used as anti-pollutant devices in the exhaust systems of automotive vehicles, both as catalytic converter substrates in automobiles, and diesel particulate filters in diesel-powered vehicles. In both applications, the ceramic honeycomb structures are formed from a matrix of thin ceramic webs which define a plurality of parallel, gas conducting channels. The web matrix is surrounded by a cylindrical or oval-shaped ceramic skin. The thickness of the ceramic webs is typically between 5.0 and 25.0 mils.

Such ceramic structures are typically manufactured by first mixing together dry particulate ceramic precursor ingredients in carefully measured proportions that will form a specific ceramic material (such as cordierite or aluminum titanate) when fired in a kiln at temperatures appropriate for material consolidation. The resulting initial precursor mix is next made into a ceramic clay by mixing substances such as water and organic solvents into the dry particulate mix. The resulting ceramic clay is plasticized by an auger or a twin screw in the chamber of an extruder, and is pushed through an extrusion plate having mutually orthogonal, narrow slots. The slots form the matrix of webs of a log-shaped extrudate. The extrudate is cut into can-shaped green body ceramic honeycomb structures, which are then fired into honeycomb ceramic structures.

Large particles may potentially interfere with the ability of the extruder to generate long production runs of the log-shaped extrudate. When such large particles clog the slots of an extrusion plate, the extrusion plate must be removed and cleaned or replaced to avoid formation of defects in the resulting web matrix.

### SUMMARY

One aspect of the invention described herein is a method of forming a ceramic precursor material for use in extruding ceramic honeycomb green bodies, comprising the following steps. First, a plurality of dry particulate ceramic precursor ingredients are mixed to achieve an initial particulate precursor mixture. This mixture includes a percentage of particles and agglomerates with the agglomerates exhibiting a size greater than the threshold size. Following mixing, the agglomerates in the initial particulate mixture are pulverized to reduce a maximum size of at least some of the agglomerates below the threshold size to form pulverized agglomerates. Finally, a portion of the ceramic precursor ingredients are separated from the initial mixture with that portion comprising at least some of the pulverized agglomerates and at least some of the particles.

A second aspect of the invention described herein is another method of forming a ceramic precursor material for use in extruding ceramic honeycomb green bodies, comprising the following steps. (1) mixing a plurality of particulate ceramic precursor ingredients into an initial mixture, wherein the initial mixture comprises particles and agglomerates, the agglomerate exhibiting a size greater than the threshold dimension; (2) pulverizing the agglomerates in a chamber to reduce a maximum size of at least some of the agglomerates below the threshold dimension to form pulverized agglomerates; (3) removing from the chamber a portion of the ceramic precursor ingredients, the portion comprising at least some of the pulverized agglomerates and at least some of the particles.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description, serve to explain the principles and operation of the invention.

### DESCRIPTION OF THE DRAWINGS

FIG. 1 is a schematic diagram illustrating the system of the invention wherein a powderizer separates the particles of the initial particulate precursor mix prior to the formation of a ceramic precursor clay from the dry precursor mix;

FIG. 2 shows comparative graphs illustrating the effect of the powderizer on the average diameter of the dry precursor mix particles; the left side show 10%, 50% and 90% of the particles (solid line) vs. the average diameters for 10%, 50% and 90% of the particles without the powderizer (dashed line); the right side shows the effect of the powderizer on the average diameter of the dry precursor mix particles for the largest 20% of the particles (solid line with squares) vs. without the powderizer (dashed line with circles), and

FIG. 3 is a table illustrating how different setting of the controls of the powderizer effect average particle distribution of the final dry precursor mix.

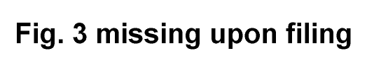

### DETAILED DESCRIPTION

While not intending to limited by theory, applicants believe that premature plugging of protective screens positioned before an extruder die is due to a combination of particle agglomerates caused by van der Waal forces and static electricity, and of micro-debris such as micro-fibers of binder materials and metal particles that were inherently present in the particulate ceramic ingredients as a result of the manufacturing techniques used, or were later introduced into the particulate ceramic ingredients from the shipping containers or packaging.

Applicants found that premature plugging can be reduced by processing the initial dry precursor mix through a powderizer (sometimes also referred to in this application as an impact and classifying mill) prior to forming the precursor clay that is ultimately extruded into the green body ceramic honeycomb structures. Hence the system of the invention includes a mixer that mixes a plurality of dry particulate ceramic precursor ingredients into an initial particulate precursor mix, and a powderizer that both pulverizes and separates the smaller diameter particles to form a final dry precursor mix. Despite the fact that such powderizers are designed to process the particles of a single ingredient, the applicants found that such a powderizer worked well to reduce or eliminate oversized particles when multiple ceramic ingredients were processed through the powderizer, and that such a powderizer outputted the processed particulates in almost exactly the same proportion as inputted, despite differences in the densities of the various ingredients. The system not only overcomes the aforementioned screen clogging problems, but also allows larger mesh, lower pressure protective screens to be used in the extruder and allows long runs of continuous extruding, thereby expediting the manufacturing process of the resulting green body structures.

A portion of the particles in the initial precursor mix have diameters that are greater than a threshold dimension. However, the pulverization of the particles of the different ingredients forming the initial precursor as well as the agglomerates helps to reduce the portion of particles and agglomerates having dimension above the threshold dimension and helps to reduce the diameter of any trace amounts of contaminating debris in the mix. The pulverization also lowers the average particulate diameter, which helps to lower the pressure applied to the protective screen during the extrusion process. In some batches, applicants have found about 90% of said particles and agglomerated in an initial precursor mix have a diameter of about 19 microns or less. By contrast, about 90% of the particles and agglomerates separated by said powderizer have a diameter of about 14 microns or less. The separation of the particles and agglomerates having dimension below the threshold dimension in the precursor mixture via cyclonic forces generated by a blower in the powderizer further reduces (if not entirely eliminates) the portion of particles having diameters that are greater than threshold dimension

The system may also include a metal particle separator that detects and separates metal particle from said initial precursor mix prior to the introduction of said mix into the powderizer. A vibratory screen may be disposed between the mixer and powderizer to separate particles, agglomerates, debris and fibers having an average diameter above a threshold dimension from said initial particulate precursor mix.

The mixer may include a mixing bin having walls formed at least in part from a porous material, a source of pressurized gas connected to an outside surface of said walls such that a flow of said initial particulate precursor mix is enhanced without the need for static-inducing vibrators that might create unwanted particle agglomerates, and a metering device that determines a feed rate of the initial mix into the powderizer.

The system may also include a digital processor that is connected to the metering device in order to control a rate of flow from the mixer to the powderizer. The powderizer may have a blower damper control and a classifier wheel speed control, both of which are also connected to the digital processor. Finally, the system may also include a particle diameter monitor connected to an outlet of the powderizer that monitors the average diameter of particles separated by the powderizer that communicates with said digital processor, and the digital processor may operate to adjust the metering device, blower damper control, and the classifier wheel speed control in response to an output of the particle/agglomerate diameter monitor to minimize the portion of the particle/agglomerate diameters that are greater than a threshold dimension

The invention further includes a method which is implemented by the system of the invention.

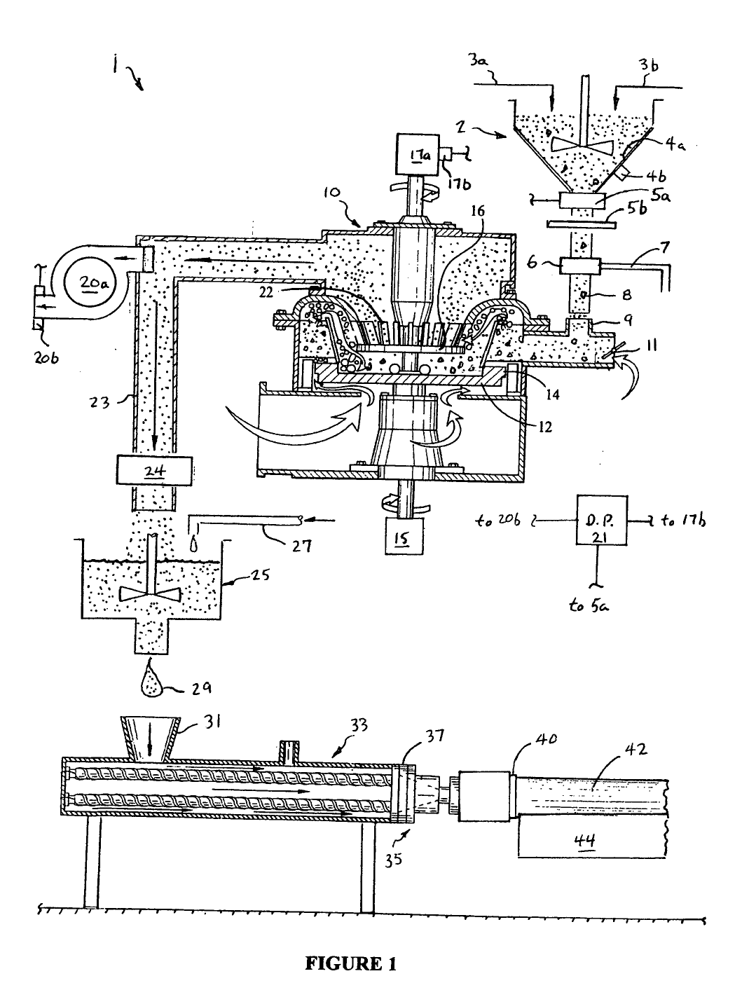

With reference now to FIG. 1, the system 1 of the invention includes a precursor mixer 2 for mixing the various ceramic precursor ingredients 3a, 3b of the final ceramic composition desired. Examples of such final ceramic compositions include cordierite and aluminum titanate. While only two ingredients 3a, 3b are shown in this example of the system, it should be noted that the number of ingredients required to form final compositions is often substantially greater. In the case of cordierite, three major ingredients are required to form the precursor mix (i.e. primarily SiO₂, Al₂O₃, MgO) along with a smaller percentage of one or more other compounds to improve, for example, thermal expansion characteristics. The particulate average diameter of the raw ingredients is selected to be about one-tenth of the slot width used in the extrusion plate of the extruder. Consequently, for a slot width of 2.5 mils, the average diameter of the particles of raw material should be 0.25 mils, or 6.35 microns, and no particle should have a diameter greater than 63.5 microns, or the slot could become clogged. The mixer 2 is lined with porous metal walls 4a which communicate with a source of compressed air 4b to promote the flow of the particulate precursor ingredients 3a, 3b down the funnel-shaped walls without the need for vibratory devices which might induce agglomerate-promoting static electricity in the ingredients.

A metering device 5a regulates the flow of initial precursor mix through the outlet of the mixer 2. Metering device 5a includes a variable speed electric motor (not shown) connected to a rotary airlock valve via an appropriate drive train (also not shown), and flow of the mix can be increased or decreased in accordance with increasing or decreasing the rpm of the variable speed motor. Upon leaving the outlet of the mixer 2, the particulate ingredients are sifted through a vibratory screen 5b in order to remove at least some of the agglomerates and debris particles or fibers which may be present in the precursor mix. Because the screen is not the primary separator of oversized particles, the screen may have a mesh size (for example, between about 6 and 12 when the ingredient particles are sized for a 2.50 mil slot) which is fine enough to remove some oversized particles but not so fine as to result in frequent cloggings and the discarding of an overly large percentage of the precursor mix. After being sifted through the vibratory screen 5b, the precursor mix is directed through a metal particle remover 6 that determines the presence of contaminating metal particles, and directs any portion of the precursor mix so contaminated to an outlet 7. To this end, the metal particle remover 6 includes an eddy current detecting circuit that detects the presence of metals via fluctuations in an induction field, and the diversion of and contaminated portion of the stream of precursor mix is accomplished via solenoid valves.

The resulting stream of sifted and de-metallized precursor mix is then directed into the inlet 9 of an impact and classifying mill or powderizer 10. While the vibratory screen 5b has eliminated a substantial portion of the oversized particles, the mix entering the inlet 9 still has an unacceptable amount of oversize particles 8, a large portion of which are agglomerates created by van der Waals forces and static electricity during the packaging of the raw ingredients 3a, 3b, and the mixing and conveying of these ingredients 3a, 3b through the mixer. The powderizer 10 substantially removes all of these oversize particles. To this end, the powderizer 10 includes a vacuum damper 11, a high speed rotor disc 12 to which a plurality of impactor hammers 14 are connected, a motor 15 for rotating the disc 12, and a classifying wheel 16 rotated by a motor 17a whose rotational speed is regulated by a motor controller 17b and the powderizer 10 also includes a blower 20a connected to an outlet of the powderizer 10. A damper control 20b controls the output of the blower 20a. The classifier wheel is circumscribed with blades 22 that generate cyclonic forces within the housing of the powderizer 10 which lift and expel particles above a certain size through outlet 23. To prevent premature wear, the impact hammers 14 of the mill 10 are faced with tungsten carbide, and various portions of the interior of the powderizer are reinforced with ceramic armor or tungsten carbide. The metering device 5a, classifier motor control 17b, and damper control 20b are preferably connected to the output of a digital processor 21 which coordinates these controls 5b, 17b, and 20b in a manner to be described hereinafter.

In operation, dry precursor mix flows out of the mixer 2 through the metering device 5a, vibratory screen 5b and metal particle remover 6 and in to the inlet 9 of the powderizer 10 as shown at a controlled rate of flow. Air currents generated by the blower 20a and regulated by the blower damper 20b pull the flow of precursor mix to the impact hammers 14 on the rotor disc 12. The impact hammers 14 proceed to pulverize the precursor mix, which breaks up oversized particles caused by agglomerates, and further lowers the average particle diameter of the mix. The pulverized precursor mix generated by the action of the impact hammers 14 is subjected to cyclonic wind forces generated by the rotation of the blades 22 of the classifying wheel 16 interacting with the air stream generated by the blower 20a and regulated by the blower damper 20b. The lighter, smaller diameter particles are conveyed by the cyclonic wind forces to the outlet 23. The heavier, larger diameter particles and agglomerates 8 are continuously recycled through the impact hammers 14 until they are broken up into particles small enough to be carried to the outlet 23 via the cyclonic wind forces within the mill 10. The system further includes a particle diameter monitor 24 located on the outlet 23 for periodically or continuously monitoring the average diameter of the particles of the final precursor mix in route to the inlet 31 of the extruder 33. In the preferred embodiment, the particle diameter monitor 24 may be a laser diffraction-type diameter monitor such as a Malvern Insitec monitor manufactured by Malvern Instruments of Southborough, Mass. Preferably, the output of the monitor 24 is connected to an input of an additional digital processor (not shown) connected to processor 22 so that the processor 22 can manipulate the controls 5a, 17b, and 20b to minimize the amount of oversize particles as well as the wear on the powderizer 10.

The applicants have observed that the powderizer 10 is able to quickly remove oversize particles from the initial precursor mix and to generate a final precursor mix out of the outlet 23 having the same proportions of ceramic ingredients 3a, 3b as was introduced in to the mixer 2. This is surprising in view of the fact that the different ceramic ingredients 3a, 3b have different densities and different hardnesses, both of which would indicate a different rate of separation by the classifying wheel 16. While applicants do not understand exactly why such serendipitous results occur, applicants believe it is because the most problematical oversize particles were the agglomerates that formed in the initial precursor mix as a result of van der Waals forces and static electricity, and that only a relatively brief amount of pulverizing and separation is necessary for these agglomerates to be effectively eliminated from the precursor mix.

The final, dry precursor mix flows into a precursor paste mixer 25, where it is mixed with substances such as water and organic solvents from source 27 to form a precursor paste or clay 29. The resulting clay 27 is introduced into the inlet 31 of an extruder 33. While the extruder 33 is indicated in FIG. 1 as being screw-type extruder, ram-type extruders may also be used in the system 1 of the invention. The extruder forces the clay 29 through an assembly 35 having a protective screen 37 that screens out just about all of the last remaining oversize particles. The screened clay is then squeezed through an extrusion plate 40 to form an extruded green body log 42 having in its interior a matrix of web walls the same thickness as the spacing between the slots in the extrusion plate 40. The extruded green body log 42 is carried by an air bearing table 44 to a cutting station (not shown) to ultimately create green body honeycomb structures that are fired into a final ceramic product.

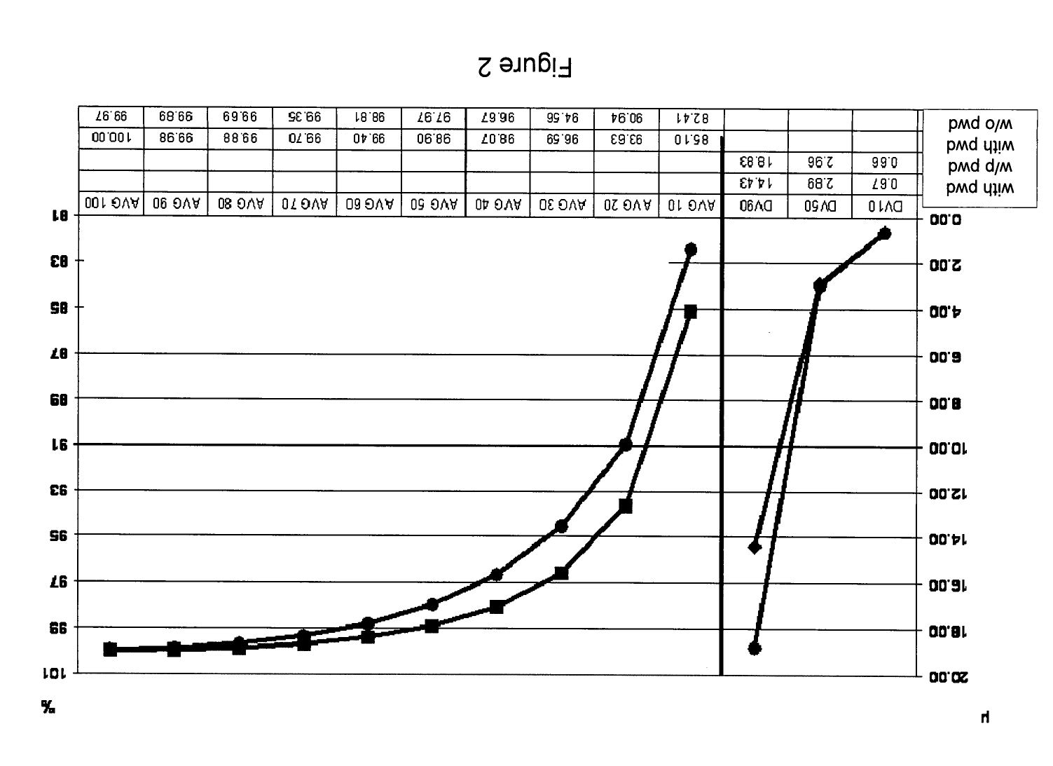

The left side of FIG. 2 is a graph illustrating the effect of the powderizer 10 on the average diameter of the dry precursor mix particles for 10%, 50% and 90% (d10, d50 and d90 respectively) of the particles. Specifically, the solid line graph illustrates the average particle diameter in such a mix processed through a mill 10, while the dashed line graph illustrates the average particle diameter in such a mix that has not been processed through such a mill 10. As is evident from these graphs, the powderizer 10 has the effect of lowering the average diameter of the precursor mix such that 90% of the particles have a diameter of 14.43 microns or less. By contrast, without the powderizer 10, 90% of the particles have a diameter of 18.83 microns or less. Such lowering of the average diameter of the particles not only has the effect of reducing the number of agglomerates 8 and oversize particles, but further helps reduce the amount of pressure needed to squeeze the resulting precursor paste 29 through the protective screen 37 of the extruder 33.

The values d10 and d50 are defined as the diameters at 10% and 50% of the cumulative particle size distribution, with d10<d50. Thus, d50 is the median particle/agglomerate diameter, and d10 is the particle/agglomerate diameter at which 10% of the particle/agglomerates are finer. The value of d90 is the particle/agglomerate diameter for which 90% of the particles/agglomerates are finer in diameter; thus d10<d50<d90. For example mixing a plurality of particulate ceramic precursor ingredients into an initial mixture, wherein the initial mixture comprises fine particles and coarse particles is interpreted to mean that the mixture exhibits an initial d90 of some initial value; for instance if the d90 was 18 microns, that would imply that 90% of the particles are 18 microns or smaller.;

The right side of FIG. 2 compares how the diameter distribution of the precursor particles is changed by the powderizer for the largest 20% of the particles. Specifically, the solid line graph marked with squares illustrates the particulate diameter distribution with the powderizer 10, while the dashed line graph marked with circles illustrates the particle distribution without the powderizer 10. Note that when the powderizer 10 is used, 99.40% of the particles have an average diameter of 60 microns or less, and hence are unlikely to clog an extrusion plate having 2.50 mil wide slots (which corresponds to 63.5 microns). By contrast, when the powderizer 10 is not used, 98.81% of the particles have an average diameter of 60 microns or less, which amounts to twice as many particles having average diameters that can potentially clog the slots of an extrusion plate 40.

Table 3 illustrates how different setting of the controls of the powderizer effect average particle distribution of the final dry precursor mix, and in particular illustrates how the digital processor 21 can adjust the settings of the metering device 5a, classifier motor control 17b, and blower damper 20b to reduce the percentage of oversized particles that must be removed by the protective screen 37 even further. The particular powderizer 10 that was used to compile the information in the Table 3 was a Sturtevant Model NSP1 available from Sturtevant, Inc. located in Hanover, Mass.

TABLE 3

| | POWDERIZER | | | | | | | | | | | | | | | |
|---|---|---|---|---|---|---|---|---|---|---|---|---|---|---|---|---|
| RUN | SETTINGS | DV10 | DV50 | DV90 | 2μ | 5μ | 10μ | 20μ | 30μ | 40μ | 50μ | 60μ | 70μ | 80μ | 90μ | 100μ |
| 1 | 1565 classifer rpm, at | 0.68 | 2.90 | 11.6 | 37.9 | 71.2 | 87.5 | 95.9 | 98.1 | 99.0 | 99.5 | 99.7 | 99.9 | 99.9 | 100.0 | 100.0 |
| | damper 80% open, motor is | | | | | | | | | | | | | | | |
| | at 50 hertz metering set | | | | | | | | | | | | | | | |
| | automatically from particle | | | | | | | | | | | | | | | |
| | size analyzer feedback | | | | | | | | | | | | | | | |
| 2 | 2500 classifier rpm; damper | 0.65 | 2.69 | 10.8 | 40.6 | 74.1 | 88.9 | 96.3 | 98.3 | 99.2 | 99.6 | 99.8 | 99.9 | 100.0 | 100.0 | 100.0 |
| | 70% (60 Hertz); automatic | | | | | | | | | | | | | | | |
| | ametering | | | | | | | | | | | | | | | |
| 3 | 2500 classifier rpm; damper | 0.60 | 2.33 | 8.0 | 42.8 | 77.2 | 93.2 | 98.3 | 99.4 | 99.8 | 99.9 | 100.0 | 100.0 | 100.0 | 100.0 | 100.0 |
| | 70% (60 hertz); metering | | | | | | | | | | | | | | | |
| | device @ 15 rpm | | | | | | | | | | | | | | | |
| 4 | 2500 classifier rpm; damper | 0.66 | 2.72 | 10.2 | 41.0 | 75.3 | 89.6 | 96.9 | 98.7 | 99.4 | 99.7 | 99.8 | 99.9 | 100.0 | 100.0 | 100.0 |
| | 70% (60 hertz); metering | | | | | | | | | | | | | | | |
| | device @ 10 rpm | | | | | | | | | | | | | | | |
| 5 | 2000 classifier rpm; damper | 0.67 | 2.77 | 10.2 | 39.9 | 74.2 | 89.5 | 96.9 | 98.7 | 99.4 | 99.7 | 99.9 | 99.9 | 100.0 | 100.0 | 100.0 |
| | 70% (60 hertz) metering | | | | | | | | | | | | | | | |
| | device @ 10 rpm | | | | | | | | | | | | | | | |
| 6 | 2000 classifier rpm; damper | 0.69 | 2.91 | 11.4 | 38.8 | 72.4 | 87.8 | 96.1 | 98.2 | 99.1 | 99.5 | 99.7 | 99.9 | 99.9 | 100.0 | 100.0 |
| | 70% (60 hertz) metering | | | | | | | | | | | | | | | |
| | device @ 18 rpm | | | | | | | | | | | | | | | |
| 7 | 2000 classifier rpm; damper | 0.71 | 3.06 | 12.2 | 37.0 | 69.8 | 86.5 | 95.5 | 97.9 | 98.9 | 99.4 | 99.6 | 99.8 | 99.9 | 100.0 | 100.0 |
| | 70% (60 hertz); metering | | | | | | | | | | | | | | | |
| | device @ 19 rpm | | | | | | | | | | | | | | | |
| 8 | 1565 classifier rpm; damper | 0.70 | 3.00 | 12.6 | 36.5 | 69.1 | 86.2 | 95.1 | 97.6 | 98.7 | 99.2 | 99.5 | 99.7 | 99.9 | 100.0 | 100.0 |
| | 70% (60 hertz) automatic | | | | | | | | | | | | | | | |
| | metering | | | | | | | | | | | | | | | |
| 9 | 330 classifier rpm; damper | 0.67 | 2.82 | 11.3 | 37.4 | 70.4 | 87.9 | 96.0 | 98.2 | 99.1 | 99.5 | 99.8 | 99.9 | 100.0 | 100.0 | 100.0 |
| | 80% (50 hertz); automatic | | | | | | | | | | | | | | | |
| | metering | | | | | | | | | | | | | | | |
| 10 | 1565 classifier rpm, damper | 0.69 | 2.92 | 11.7 | 37.4 | 70.7 | 87.3 | 95.9 | 98.1 | 99.0 | 99.5 | 99.7 | 99.9 | 99.9 | 100.0 | 100.0 |
| | 80% (50 hertz), automatic | | | | | | | | | | | | | | | |
| | metering | | | | | | | | | | | | | | | |

The first settings in Run #1 were the ones initially set by the powderizer 10 automatically from feedback from the particle diameter monitor 24. Run #1 of this table indicates that the average diameter of 99.7% of the particles in the final precursor mix may be reduced to 60 microns or less when the metering device 5a is set automatically from feedback from the particle diameter monitor 24, the classifier wheel motor control 17b is set to 1565 rpm, the blower damper control 20 is set to 80% open. The blower motor is operated at a current frequency of 50 Hz. The resulting 99.7% compares favorably to only 98.81% of the particles having an average diameter of 60 microns or less when the powderizer 10 is not used (from the table in FIG. 2A) and indicates that the powderizer, at the settings of Run #1, reduces oversize particles and agglomerates by 75% (i.e., 1.19% being oversized without the powderizer vs. only 0.3% being oversized with the powderizer). The best results, however, were achieved with the settings of Run #3. Here, setting the metering device 5a to 15 rpm, the classifier wheel motor control to 17b to 2500 rpm, the blower damper control 20b to 70%, and operating the blower motor at a current frequency of 60 Hz, resulted in 100% of the particles having an average diameter of 60 microns or less.

Different modifications, additions, and variations of this invention may become evident to the persons in the art. All such variations, additions, and modifications are encompassed within the scope of this invention, which is limited only by the appended claims, and the equivalents thereto.

What is claimed:

1. A method of forming honeycomb bodies, the method comprising:
mixing a plurality of particulate ceramic precursor ingredients into an initial mixture, wherein the initial mixture comprises particles and agglomerates, and the agglomerates have a size greater than the threshold size;
pulverizing the agglomerates to reduce a maximum size of at least some of the agglomerates below the threshold size to form pulverized agglomerates; and
separating from the initial mixture a portion of the ceramic precursor ingredients, the portion comprising at least some of the pulverized agglomerates and at least some of the particles.

2. The method of claim 1 wherein the pulverizing and separating occur simultaneously.

3. The method of claim 1 wherein the ceramic precursor ingredients are present in the initial mixture in a first set of ratios with respect to each other, and wherein the ceramic precursor ingredients are present in the portion separated in substantially the same set of ratios.

4. The method of claim 1 wherein some of the particles have a size greater than the threshold size in the initial mixture and are reduced in size below the threshold size during the pulverizing.

5. The method of claim 1 wherein none of the particles has a size greater than the threshold size.

6. The method of claim 1 wherein the threshold size is greater than 70 microns.

7. The method of claim 1 wherein the threshold size is less than 90 microns.

8. The method of claim 1 wherein the threshold size corresponds to a maximum linear dimension.

9. The method of claim 1 wherein the threshold size corresponds to an average diameter.

10. The method of claim 1 further comprising monitoring at least one particle size of the separated portion of the ceramic precursor ingredients simultaneous with the separating.

11. The method of claim 1 further comprising monitoring the initial mixture for metal contaminants, and separating metal contaminated particles from the initial mixture prior to the pulverizing.

12. The method of claim 1 further comprising mixing the separated portion with a liquid to form a plasticized batch.

13. The method of claim 12 further comprising extruding the plasticized batch into a honeycomb extrudate.

14. The method of claim 13 wherein the honeycomb extrudate comprises a wall thickness less than 5 mils.

15. The method of claim 13 further comprising cutting the honeycomb extrudate into honeycomb bodies.

16. The method of claim 15 further comprising drying the honeycomb bodies.

17. The method of claim 16 further comprising firing the dried honeycomb bodies.

18. A method of forming a honeycomb body, the method comprising:
mixing a plurality of particulate ceramic precursor ingredients into an initial mixture, wherein the initial mixture comprises particles and agglomerates, and the agglomerates have a size greater than the threshold dimension;
pulverizing the agglomerates in a chamber to reduce a maximum size of at least some of the agglomerates below the threshold dimension to form pulverized agglomerates;
removing from the chamber a portion of the ceramic precursor ingredients, the portion comprising at least some of the pulverized agglomerates and at least some of the particles.

19. A method of forming a honeycomb body, the method comprising:
mixing a plurality of particulate ceramic precursor ingredients into an initial mixture, wherein the initial mixture comprises fine particles and coarse particles and exhibits has an initial d90 value;
pulverizing the initial mixture in a chamber to reduce a size of at least some of the ceramic precursor ingredients;
removing from the chamber a portion of the ceramic precursor ingredients, the portion having a pulverized d90 value which is at least 10% lower than the initial d90.

20. The method of claim 19 wherein the pulverized d90 is at least 20% lower than the initial d90.

21. The method of claim 19 wherein the pulverized d90 is at least 30% lower than the initial d90.

22. The method of claim 19 wherein the initial d90 is greater than 18 microns.

23. The method of claim 19 wherein the pulverized d90 is less than 15 microns.

24. The method of claim 19 further comprising, during the pulverizing, reducing the size of the ceramic precursor ingredients having a size greater than d50 in the initial mixture.

25. The method of claim 19 wherein the initial mixture comprises agglomerates having a size greater than d50 in the initial mixture.
